(19) United States
(12) Patent Application Publication
(10) Pub. No.: US 2006/0276565 A1
(43) Pub. Date: Dec. 7, 2006

(54) Retroflective polymeric compounds and articles made from them

(76) Inventors: Craig Polta, Norwalk, OH (US); Scott Weber, Sylvania, OH (US)

Correspondence Address: POLYONE CORPORATION, 33587 WALKER ROAD, AVON LAKE, OH, 44012, US

(21) Appl. No.: 10/570,932

(22) PCT Filed: Sep. 3, 2004
(86) PCT No.: PCT/US04/28674

§ 371 Date: Mar. 8, 2006

Related U.S. Application Data
(60) Provisional application No. 60/506,375, filed on Sep. 25, 2003.

(51) Int. Cl. F21V 7/22

(52) U.S. Cl. 523/172; 523/223

(57) ABSTRACT

A retroflective polymeric compound is disclosed. The compound includes a thermoplastic polymer, glass micro-spheres, and metallic flakes. At least some of the glass microspheres are metallically coated. The metallic flakes are preferably aluminum. Optionally, colorants can be included in the polymeric compound. Articles made from the polymeric compound are also disclosed.

### CLAIM OF PRIORITY

This application claims priority from U.S. Provisional Patent Application Serial Number 60/506,375 bearing Attorney Docket Number 12003016 and filed on Sep. 25, 2003.

### FIELD OF THE INVENTION

This invention relates to polymer compounds having additives that enhance retroreflectivity of outer surfaces of the compounds.

### BACKGROUND OF THE INVENTION

During nighttime or dimly-lit conditions, seeing unlit objects is a considerable challenge. Retroreflectivity greatly improves seeing unlit objects by concentrating the reflection of incident light toward the source of that light.

One type of unlit object is a motor vehicle when stationary and unpowered. Governmental regulations require the placement of reflectors and retroreflectors in certain locations of a motor vehicle, particularly at locations where lighting is typically found, e.g., parking lights, tail-lights, and side-lights.

Truck trailers can have outer edges outlined with retroreflective materials, using so-called conspicuity marking tapes.

### SUMMARY OF THE INVENTION

Not all exterior locations of motor vehicles are required for retroreflective treatment. Yet many parts such as mirrors, handles, hood ornaments, and radio antennae all protrude from a larger surface of a motor vehicle. These objects can cause injury or death if a person collides with any of them because they are generally smaller than the person, a part of a larger surface, and are undetectable in nighttime or dimly-lit conditions.

Therefore, there is a need in the art to provide retroreflectivity to parts of motor vehicles or other articles that are potential sources of injury to persons. Because these parts or articles can be made from polymeric resins, which is an advantage for other manufacturing and performance reasons, the art especially needs a means to providing retroreflectivity in a plastic part or other article that might be a potential cause of personal injury.

The art does know to include glass microspheres or beads in a variety of binders, resins, and the like to provide retroreflectivity. Nonetheless, the amount of retroreflectivity has been found to be inadequate for use in an automobile body part, such as a side mirror housing.

The present invention provides a solution to the problems in the art by using a combination of additives in a polymeric compound that dramatically increases the retroreflectivity, qualitatively and quantitatively, as compared with a polymeric compound that contains only glass microspheres or beads.

One aspect of the present invention is a polymeric compound, comprising (a) a thermoplastic polymer capable of forming an article via extrusion or molding; (b) glass microspheres; and (c) metallic flakes.

Preferably, at least some of the glass microspheres include a metallic coating thereon.

Another aspect of the present invention is an article made from the polymeric compounds of the present invention.

It has been found that the combination of glass microspheres, metallic-coated glass microspheres, and metallic flakes results in retroreflectivity that causes at least a portion of the surface of the article made from the polymeric compound to reveal its presence when light is shone on that portion of the surface.

A feature of the invention is that the retroreflectivity is throughout the bulk of an article made from the polymeric compound of the present invention, meaning that retroreflectivity can not be removed, as might happen if the retroreflectivity were provided to the article merely on the outer surface.

Another feature of the invention is the retroreflectivity resides on all surfaces. Because retroreflectivity is imparted without regard to the shape of the article, the retroreflectivity inherent in the polymer compound of the present invention allows any shape to be made therefrom. Therefore, an automobile part that is composed of compound curves will nonetheless have the property of retroreflectivity at all locations on the outer surface of that part. In the case of an automobile mirror housing having flat surfaces, simple curved surfaces, and compound curved surfaces, no matter from which direction light is shone on that housing, the housing will return the light via retroreflectivity.

An advantage of the invention is that the polymeric compound adds retroreflectivity without undue expense of the additives that provide it.

It is believed that this invention will increase retroreflection in all colorspace, allowing both styling and design elements to be retained in an automobile part that adds an additional safety feature.

Other features and advantages will become apparent in the following discussion of embodiments.

### Embodiments of the Invention

Thermoplastic

Any thermoplastic compound suitable for extrusion or molding is acceptable for use in the present invention. Non-limiting examples include homopolymers and copolymers of the following thermoplastics: polyolefins, polyhaloolefins, polyamides, polyesters, polycarbonates, polystyrenes, polysiloxanes, and the like, and blends, mixtures, alloys, and other combinations of them. Among these, the following thermoplastics useful in industry are desirable: acrylic-styrene-acrylonitrile (ASA), acrylonitrile-butadiene-styrene (ABS), acetals, acrylics, aminopolymers (melamine/urea), cellulosics, epoxies, fluoroplastics, nylons, phenol-formaldehydes, polycarbonates, polyesters, polyesters, polyolefins (polyethylene and polypropylene), polystyrenes, polyurethanes, polyvinyl chloride and chlorinated polyvinyl chloride, and any of the broad category of thermoplastic elastomers.

Among all of these possibilities, for use in exterior automotive parts, ASA and ABS are preferred. More preferred is an ASA commercially available from Bayer Corporation under the brand “Centrex HGM”.

The amount of thermoplastic can range from about 60 to 90 weight percent of the total polymeric compound, and preferably from about 70 to 80 weight percent.

Microspheres

Glass microspheres, including metallic-coated microspheres, are well known to serve as refractors, reflectors, and retroreflectors of light upon surfaces or articles which contain them. An example of such disclosure is found in U.S. Pat. No. 6,525,111 (Spencer et al.). Any conventional microsphere useful to provide retroreflectivity is acceptable for use in this invention.

Of the many types of glass for microspheres, those made from barium titanate are preferred, particularly those made by Prizrnalite Industries, Inc. of New York, N.Y. USA.

Pure barium titanate is a clear crystalline ceramic having a refractive index of 2.40 and a melting point of 1625° C. Barium titanate microbeads are dense clear spheres, consisting primarily of BaTiO₃, but also containing substantial concentrations of Sio₂, B₂O₃ and CaO, as well as traces of other metal oxides. These beads are produced in conventional manner. They have high specific heat and thermal conductivity properties and low thermal expansion properties. Barium titanate in the form of microspheres preferably have a size in diameter up to about 701 μm, more preferably between about 5 μm and 50 μm. The barium titanate microspheres also are inert, oxidation-resistant, non-reactive with the thermoplastic resin and other ingredients, and have a low aspect ratio.

More preferably, at least some of the barium titanate microspheres are coated with a metallic material to further increase retroreflectivity. These microspheres are sometimes called hemispherically-metallized glass beads. Of the metals available, because of availability and cost, aluminum is the preferred metal.

Priznalite Industries Inc. is a source of barium titanate microspheres, both uncoated and metallically-coated with aluminum.

The amount of microspheres can range from about 12 to about 30, and preferably from about 15 to about 25 weight percent of the total polymeric compound.

Metallic Flakes

The present invention departs from convention by including metallic flakes in addition to metallically-coated microspheres in a polymeric compound to dramatically increase the amount of retroreflectivity in an article molded from such polymeric compound.

Any metallic flake can be used in the present invention with aluminum, copper, silver, and gold being possible. But because of availability and cost, aluminum flake is preferred.

The size of the flakes can range from about 20 μm to about 200 μm, and preferably from about 25 μm to about 100 μm.

Commercially available sources of aluminum flakes are Eckart and Silberline, with the latter being preferred with its Sparkle Silver brand line of aluminum flakes.

The amount of metallic flakes can range from about 0.2 to about 1.5, and preferably from about 0.5 to about 1.0 weight percent of the total polymeric compound.

Optional Colorant

Any conventional colorant useful in thermoplastic compounding is acceptable for use in the present invention. Conventional colorants can be employed, including inorganic pigments such as titanium dioxide, iron oxide, chromium oxide, lead chromate, carbon black, silica, talc, china clay, metallic oxides, silicates, chromates, etc., and organic pigments, such as phthalocyanine blue, phthalocyanine green, carbazole violet, anthrapyrimidine yellow, flavanthrone yellow, isoindoline yellow, indanthrone blue, quinacridone violet, perylene reds, diazo red and others.

The amount of colorant can range from none at all to about 3.0, and preferably from about 1.5 to about 2.0 weight percent of the total polymeric compound.

Process of Compounding

Any conventional means to thoroughly mix the ingredients can be used in the present invention. Preferably, the ingredients are mixed using any conventional high intensity mixing apparatus without any special order of addition, at ambient temperature and sufficient mixing speed to thoroughly mix the ingredients.

### USEFULNESS OF THE INVENTION

It has been found that use of metallic flake in the polymeric compound of the present invention significantly improves retroreflectively both qualitatively and quantitatively when compared with polymeric compounds that contain only microspheres, even those with at least some metallically-coated microspheres.

Articles that can benefit from polymeric compounds of the present invention are limited only by imaginations of those skilled in the art. Whether for purposes of safety or style, the ability to make a retroreflective polymeric article of any three dimensional shape is now possible. Non-limiting examples of articles include motor vehicle parts (e.g., side mirrors, door handles, antennae, hood ornaments, rear spoilers, and other protruding items from larger surfaces of such vehicles); safety restraints and guides in buildings and other structures where flashlights might be used in the event of a power outage (e.g., railings, fire extinguisher housings, etc.); decorative embellishments for walls, ceilings, and floors in intentionally dimly-lit interior locations (e.g., night clubs, haunted houses, etc.); location and directional markers for nighttime driving (e.g., markers for location of roadways and fire hydrants in heavy snow conditions); and other items where the need for plastic performance and cost is matched with the need for retroreflectivity throughout the bulk of the item.

### EXAMPLE

The following ingredients were mixed together using a 30 quart Hobart mixer operating at normal speed and room temperature.

TABLE 1

| | | | Comparative | |
|---|---|---|---|---|
| | | | Example A | Example 1 |
| Item | Source | Purpose | (Wt. %) | (Wt. %) |
| Raven 5000 | Columbian | Carbon Black | 1.76 | 1.76 |
| Ultra Black | Chemicals | Pigment | | |
| Powder | | | | |
| Aluminum | Prizmalite | Retroreflective | 16.00 | 16.00 |
| Coated BaTiO₃ | Industries | Beads | | |
| Microspheres | | | | |
| (38 μm) | | | | |
| Uncoated | Prizmalite | Retroreflective | 4.00 | 4.00 |
| BaTiO₃ | Industries | Beads | | |
| Microspheres | | | | |
| (8.5 μm) | | | | |
| Sparkle Silver | Silberline | Retroreflective | — | 0.88 |
| Aluminum | Mfg. Co. | Flakes | | |
| Flakes | | | | |
| Centrex HGM | Bayer Corp. | Thermoplastic | 78.24 | 77.36 |
| Natural ASA | | | | |

Plaques of both Comparative Example A and Example 1 were made and had one ungrained surface.

A qualitative view by those of ordinary skill in the art immediately revealed that Example 1 was much more retroreflective than Comparative Example A, approximately 30-50% on the ungrained surface. The combination of small uncoated BaTiO₃ glass beads, Al-coated BaTiO₃ glass beads, and Al flakes improves retroreflectivity of a black plastic article.

The invention is not limited to these embodiments. The claims follow.

What is claimed is:

1. A retroreflective article, comprising:
a polymeric compound, comprising:
(a) a thermoplastic polymer capable of forming the article via extrusion or molding;
(b) glass microspheres; and
(c) metallic flakes,
wherein the glass microspheres and metallic flakes impart retroreflectivity to the article, and
wherein the retroreflectivity resides on all surfaces and throughout bulk of the article.

2. The article of claim 1, wherein at least some of the glass microspheres are coated with a metal.

3. The article of claim 1, wherein the metal is aluminum and wherein the metallic flakes are aluminum.

4. The article of claim 1, wherein the thermoplastic polymer is selected from the group consisting of pplyolefins, polyhaloolefins, polyamides, polyesters, polycarbonates, polystyrenes, polysiloxanes, and blends, mixtures, and alloys of them.

5. The article of claim 1, wherein the thermoplastic polymer is acrylic-styrene-acrylonitrile.

6. The article of claim 1, wherein the metallic flakes are present in an amount of from about 0.2 to about 1.5 weight percent of the compound.

7. The article of claim 1 wherein the compound further comprises colorant.

8. The article of claim 1, wherein the article is a motor vehicle part.

9. The article of claim 1, wherein the surfaces comprise flat surfaces, simple curved surfaces, compound curve surfaces or combinations thereof.

10. The article of claim 1, wherein the article is safety restraint or guide.

11. The article of claim 1, wherein the article is a decorative embellishment for an intentionally dimly-lit interior location.

12. The article of claim 1, wherein the article is a location or directional marker for exterior locations.

13. The article of claim 2, wherein the metal is aluminum and wherein the metallic flakes are aluminum, and wherein the thermoplastic polymer is selected from the group consisting of polyolefins, polyhaloolefins, polyamides, polyesters, polycarbonates, polystyrenes, polysiloxanes, and blends, mixtures, and alloys of them.

14. The article of claim 2, wherein the thermoplastic polymer is acrylic-styrene-acrylonitrile and wherein the metallic flakes are present in an amount of from about 0.2 to about 1.5 weight percent of the compound.

15. The article of claim 2 wherein the compound further comprises colorant.

16. The article of claim 2, wherein the surfaces comprise flat surfaces, simple curved surfaces, compound curve surfaces or combinations thereof.

17. The article of claim 2, wherein the article is a motor vehicle part.

18. The article of claim 2, wherein the article is safety restraint or guide.

19. The article of claim 2, wherein the article is a decorative embellishment for an intentionally dimly-lit interior location.

20. The article of claim 2, wherein the article is a location or directional marker for exterior locations.
